(19) United States
(12) Patent Application Publication
(10) Pub. No.: US 2012/0164417 A1
(43) Pub. Date: Jun. 28, 2012

(54) SELF-WOUND TAPE

(75) Inventor: Albert G. Marquis, Lowell, MA (US)

(73) Assignee: BERRY PLASTICS CORPORATION, Evansville, IN (US)

(21) Appl. No.: 13/312,598

(22) Filed: Dec. 6, 2011

Related U.S. Application Data
(60) Provisional application No. 61/420,206, filed on Dec. 6, 2010.

(51) Int. Cl. B32B 7/02; B05D 3/12; B05D 5/10; B32B 7/12; B26D 3/08

(52) U.S. Cl. 428/215; 428/343; 427/177

(57) ABSTRACT

A self-wound flashing tape comprising a release-treated polyester film coated on the non-treated side with a butyl-based adhesive. The tape may be provided in roll form without a release liner and can be easily unwound.

### CROSS REFERENCE TO RELATED APPLICATION

This patent application claims priority to U.S. Provisional Patent Application No. 61/420,206, filed Dec. 6, 2010, the disclosure of which is incorporated herein by reference in its entirety.

### FIELD

The present disclosure relates to a flexible tape for adhering to structures to provide waterproofing and resistance to air flow. The disclosure further relates to a pressure-sensitive adhesive tape for adhering members of a structure, such as those in a house, to each other. For example, the tape may be used for flashing around windows or doors.

### BACKGROUND

The use of tapes to provide waterproofing and air sealing in houses and other structures has provoked the development of a range of application specific tapes commonly referred to as “flashing tapes.” Flashing tapes are used during the construction and retrofitting of structures to provide a seal between adjacent units. For example, a flashing tape may be used to seal the gap between a window and a wall unit. The flashing tape is part of an overall system which provides the structure with air-tightness as it prevents the flow of air and loss of heat through gaps which may otherwise be present, thereby improving the insulation quality the seal.

Flashing tapes based on pressure-sensitive adhesives are currently available in a variety of configurations. For example, the Nashua® OptiFlash® products and Polyken® Foilastic® and Shadowlastic® products are flashing tapes having either an aluminum foil or black high density polyethylene (HDPE) backing. The adhesive used is based on a butyl rubber composition. These flashing tapes include either a polymer coated kraft paper release liner or a blue low-density polyethylene release liner that enables the tape to be wound on a roll without permanently affixing to itself. The release liner is a necessary component of these tapes when packaged as a roll because the adhesive layer on the inward-facing surface will adhere to the outward-facing surface of the backing if the release liner is not incorporated. Without the release liner, the tape could be wound in a roll, but not unwound without damaging the tape. When the tape is unwound for use, the release liner is removed from the adhesive and the tape is applied to the structure. The removed release liner is discarded as waste or recycled, creating waste byproduct, increasing the amount of material needed to make the product and increasing the cost of manufacture.

There is a need for a flashing tape in roll form without a release liner that can be easily unwound. There is also a need for a flashing tape provided in roll form without a release liner such that the tape can be applied in overlapping strips to a surface so that the strips adhere to each other where overlapped.

### SUMMARY

The present disclosure provides, in one exemplary embodiment, an adhesive tape comprising a polymeric backing and a pressure-sensitive adhesive for use as a flashing tape. The flashing tape can be applied to a structure so that the adhesive side adheres to the structure.

In illustrative embodiments, an adhesive tape comprises a polymeric backing layer and a pressure-sensitive adhesive layer. The polymeric backing layer and the pressure-sensitive adhesive layers are configured as a self-wound flashing tape without a removable release liner that can be wound on a roll. In one embodiment, the polymeric backing layer is between about 0.5 and about 2 mils in thickness and the pressure-sensitive adhesive layer is between about 9 mils and about 60 mils in thickness. In another embodiment, a ratio of thickness of the pressure sensitive adhesive layer and the polymeric backing layer is greater than about 10:1.

In one illustrative embodiment, a method of producing a roll of flashing tape is provided comprising the steps of coating a pressure-sensitive adhesive composition onto a polymeric backing to make a coated film, winding the coated film around a core positioned on a master drum without the introduction of a removable release liner, and score cutting the coated film to produce the roll of flashing tape. Illustratively, the coating can be shear coating or die profile feed coating. In one embodiment, the coating is shear coating and the shear coating step includes the step of positioning the polymeric backing between a first roll and a second roll of a calendar, the first roll being in contact with the polymeric backing and the second roll positioned to define a gap between the polymeric backing and the second roll. In another embodiment, the shear coating step includes the step of adjusting the gap so that the polymeric backing having a thickness of between about 0.5 mils and about 2 mils is coated with the pressure-sensitive adhesive composition at a thickness of between 9 mils and 60 mils. In another embodiment, the score cutting step introduces minor blems on the edges of the flashing tape which allows the tape to be hand-tearable.

### BRIEF DESCRIPTION OF THE DRAWINGS

The detailed description particularly refers to the accompanying figures in which:

FIG. 1 is a perspective view of a first exemplary embodiment of a self-wound tape in accordance with the present disclosure showing a polymeric backing layer having a non-removable release coating and a pressure-sensitive adhesive layer, wherein the polymeric backing layer and the pressure-sensitive adhesive layers are configured as a self-wound flashing tape without a removable release liner; and

FIG. 2 is sectional view taken along line 2-2 of FIG. 1 showing that the tape is arranged to include in a series, an outer adhesive surface, an adhesive layer, an interface between the adhesive layer and a first surface of the polymeric backing, a polymeric backing layer, and an outer surface of the polymeric backing layer in contact with an non-removable release layer.

FIG. 3 is a table of test results for Example 1.

FIG. 4 is a table of test results for Example 1.

### DETAILED DESCRIPTION

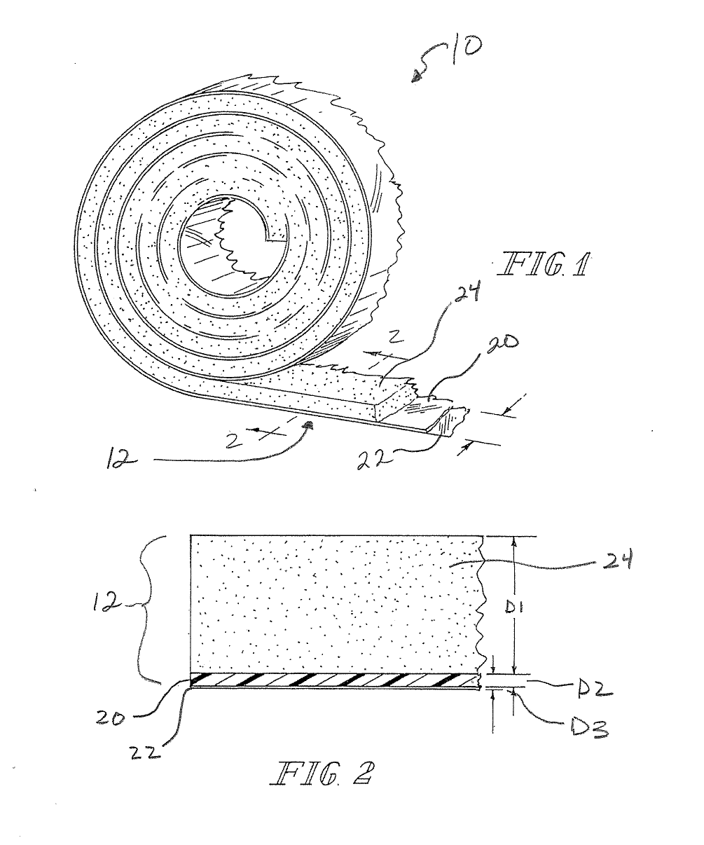

As shown in FIG. 1, an adhesive tape 12 in accordance with one exemplary embodiment of the present disclosure comprises a polymeric backing layer 20 having a non-removable release layer 22 and a pressure-sensitive adhesive layer 24. In illustrative embodiments, polymeric backing layer 20, non-removable release layer 22, and pressure-sensitive adhesive layer 24 are configured as a roll of self-wound flashing tape 10 without a removable release liner.

As shown in FIG. 2, polymeric backing layer 20 is thin in comparison to pressure-sensitive adhesive layer 24. The thickness of pressure-sensitive adhesive layer 24 is characterized by dimension D1. The thickness of polymeric backing layer 20 is characterized by dimension D2. The thickness of non-removable release layer 22 is characterized by dimension D3. In one embodiment, the ratio of D1:D2 is greater than 4:1. In another embodiment, the ratio of D1:D2 is greater than 9:1. In another embodiment, the ratio of D1:D2 is between about 9:1 and 120:1. In one embodiment, dimension D1 is between about 9 mils and about 60 mils. As used herein, the unit mil is used as a thickness equal to one thousandth (10⁻³) of an inch which is approximately equal to 0.0254 millimeters. In another embodiment, dimension D2 is between about 0.5 and 2 mils. In another embodiment, dimension D3 is between about 1 and 100 microns.

In illustrative embodiments, pressure-sensitive adhesive layer 24 may be soft and thick. As used herein, the term “thick” is used in the context of the thickness of an adhesive layer which is between about 9 mils and about 60 mils in thickness though thinner or thicker layers may be used, as appropriate. As used herein, the term “soft” means that the adhesive composition is capable of adhering to various surfaces having a broad range of surface roughness at temperatures as low as about 0° C. In illustrative embodiments, soft adhesives are capable of adhering to various surfaces at temperatures significantly lower than 0° C., for example at temperatures of about −18° C. In particular, a soft adhesive does not behave in a purely elastic manner and has a relatively low modulus. Thus, when a soft adhesive is brought into contact with a rough solid surface, it will deform to increase the degree of intimacy between the surface and adhesive. This can be contrasted from a hard adhesive which would have a large modulus and deform in an elastic manner. A hard adhesive would not deform when brought into contact with a rough surface; thus, adhesion between the hard adhesive and the rough surface would be limited to the raised portions of the rough topography. Another aspect of softness is that the softness is maintained at lowered temperatures. In illustrative embodiments of the present disclosure, the soft adhesive maintains its pressure-sensitive characteristics at temperatures below about 0° C. Illustratively, a soft adhesive will bond to a substrate when both the adhesive composition and the substrate are at or below about 0° C.

The softness of an exemplary adhesive of the present disclosure may be inferred from the adhesion of a tape to various substrates. In one embodiment, the tape of the present disclosure exhibits an adhesion to plywood according to ASTM D903-93 of greater than about 60 oz/in (0.7 N/mm). In another embodiment, the tape exhibits an adhesion to plywood of greater than about 100 oz/in (1.1 N/mm). In another embodiment, the tape exhibits an adhesion to plywood of between about 90 oz/in (1 N/mm) and about 300 oz/in (3.3 N/mm). In another embodiment, the tape of the present disclosure exhibits an adhesion to steel according to PSTC-1 of greater than about 100 oz/in (1.1 N/mm). In another embodiment, the tape exhibits an adhesion to steel of greater than about 120 oz/in (1.3 N/mm). In yet another embodiment, the tape exhibits an adhesion to steel of between about 110 oz/in (1.2 N/mm) and about 400 oz/in (1.5 N/mm). In one embodiment, the tape of the present disclosure exhibits an adhesion to oriented strand board (OSB) according to ASTM D903-93 of greater than about 60 oz/in (0.7 N/mm). In another embodiment, the tape exhibits an adhesion to OSB of greater than about 100 oz/in (1.1 N/mm). In yet another embodiment, the tape exhibits an adhesion to OSB of between about 90 oz/in (1.0 N/mm) and about 300 oz/in (3.3 N/mm). In one embodiment, the tape of the present disclosure exhibits an adhesion to backing (lap adhesion) according to ASTM D903-93 of less than about 20 oz/in (0.2 N/mm). In another embodiment, the tape exhibits an adhesion to backing of less than about 10 oz/in (0.1 N/mm). In another embodiment, the tape exhibits an adhesion to backing of between about 10 oz/in (0.1 N/mm) and 0.1 oz/in (0.001 N/mm).

In illustrative embodiments, the room temperature adhesion properties as set forth herein may be compromised for enhanced cold temperature performance. For example, the incorporation of a harder plasticizer may decrease room temperature adhesion but benefit cold temperature adhesion. With the objective of high cold temperature adhesion, illustrative embodiments of the tape exhibit an adhesion to plywood according to D 3330/D 3330M—04 Test Method F of greater than about 30 oz/in (0.3 N/mm) at 73° F. In another embodiment, the tape exhibits an adhesion to plywood of greater than about 40 oz/in (0.4 N/mm) at 73° F. In one embodiment, the tape exhibits an adhesion to plywood of greater than about 30 oz/in (0.3 N/mm) at 30° F. In another embodiment, the tape exhibits an adhesion to plywood of greater than about 40 oz/in (0.4 N/mm) at 30° F. In one embodiment, the tape exhibits an adhesion to plywood of greater than about 15 oz/in (0.16 N/mm) at 15° F. In another embodiment, the tape exhibits an adhesion to plywood of greater than about 25 oz/in (0.27 N/mm) at 15° F. In one embodiment, the tape exhibits an adhesion to plywood of greater than about 5 oz/in (0.05 N/mm) at 0° F. In another embodiment, the tape exhibits an adhesion to plywood of greater than about 10 oz/in (0.1 N/mm) at 0° F.

In illustrative embodiments, the tape exhibits an adhesion to anodized aluminum according to D 3330/D 3330M—04 Test Method F of between about 50 oz/in (0.5 N/mm) and about 200 oz/in (2.2 N/mm) at 73° F. and 0° F. In one embodiment, the tape exhibits an adhesion to anodized aluminum of between about 80 oz/in (0.9 N/mm) and about 300 oz/in (3.3 N/mm) at 30° F. and 15° F. In another embodiment the tape exhibits an adhesion to extruded polyvinyl chloride (PVC) according to D 3330/D 3330M—04 Test Method F of between about 50 oz/in (0.5 N/mm) and about 200 oz/in (2.2 N/mm) at 73° F. and 30° F. In yet another embodiment, the tape exhibits an adhesion to extruded PVC of between about 10 oz/in (0.9 N/mm) and about 100 oz/in (3.3 N/mm) at 15° F. and 0° F.

The present disclosure describes a self-wound flashing tape including a thick and soft adhesive layer. As used herein, the term “self-wound” means that the adhesive tape can be wound upon itself and subsequently unwound without the inclusion of a removable release liner and without appreciable damage to the tape or fracturing of the adhesive layer. The adhesive layer has a propensity to stick to any surface with which it comes into contact. If the force of adhesion between the adhesive layer and the surface is greater than the forces holding the adhesive layer together, the adhesive layer will fracture upon applying a separation force. One type of fracturing is called “blocking.” Blocking occurs when the adhesive fractures and is present on both sides of a tape after unwinding. Blocking of an adhesive layer during tape unwind is considered a negative attribute for a self-wound tape and may render the unwound tape unsuitable for any particular application. The present disclosure describes a self-wound tape with a thick and soft adhesive layer that does not exhibit blocking upon unwind.

One aspect of the present disclosure is that the propensity to exhibit blocking is elevated for soft and thick adhesives. Because of this propensity, tapes which include soft and thick adhesives have used removable release liners. A removable release liner has physical and chemical characteristics that significantly lower the energy needed to achieve separation between the liner and an adhesive tape. As such, a removable release liner can be designed to prevent blocking of a soft and thick adhesive composition. The present disclosure describes a tape configured with a non-removable release coating that avoids incorporation of a removable release liner so that blocking is prevented upon unwinding a roll of the adhesive tape. As such, the present tape is easier for the installer to install as it does not require the removal of a removable release liner. Furthermore, the present tape avoids the generation of removable release liner refuse at the installation site, thus providing both an environmental and an installation site cleanliness advantage, as well as decreasing the need for additional material to form the tape roll.

An exemplary self-wound tape in accordance with the present disclosure comprises a soft and thick adhesive in combination with a non-removable release coating. While not being bound to a particular theory, it is believed that a release coating has both physical characteristics and chemical functionality that avoids strong interactions with adhesive compositions. For pressure-sensitive adhesives, the strong chemical interactions are believed to be primarily van der Waals interactions and/or non-covalent chemical bonding (hydrogen bonding and ionic interactions). A release coating thus has surface chemistry that minimizes the release coating's participation in van der Waals interactions and other attractive forces. However, strong chemical interactions derived from molecular interactions are not the only source of adhesive forces for pressure sensitive adhesives. In particular, on macroscopic length scales adhesion is also derived from the intimacy of contact between the adhesive material and the substrate surface. In particular, solid surfaces display some degree of surface roughness. An effective adhesive composition will have an elastic modulus sufficiently low that it deforms to some extent when contacted to the rough surface. The greater the deformation, the greater the intimacy of the contact between the adhesive and the surface. A substance having an elastic modulus greater than about 10⁵ Pa is generally not considered sticky.

In one aspect, the separation of an adhesive tape from a substrate requires a certain amount of energy dissipation. The amount of energy dissipation may be measured with a peel test, but it is well known that the peel force is dependent on the manner in which the tape is peeled from the substrate. For example, peel force is dependent on geometrical and mechanical properties of the sample and the test, for example, peel velocity, peel angle, and adhesive thickness. Standard methods (e.g., ASTM D903-93) provide means for quantitatively comparing adhesive tapes.

While geometrically confounding, there has emerged a mechanistic understanding that has been established that is relevant to the current disclosure. In particular, it has been determined that adhesive tapes that have high peel forces exhibit the formation of cavities and fibrils during peeling. As a force is applied to separate an adhesive and the substrate, cavities form within the adhesive materials. In the case of voids being originally trapped between the adhesive material and the substrate, those voids grow during this cavitation process. As the surfaces move further apart, the adhesive is pulled to form fibrils. There are three phases to the separation: (i) initiation by cavitation, (ii) cavity growth, and (iii) fibril formation and stability. The initiation of cavitation requires the largest force, the size of that force being related to the process of cavity growth in a rubbery elastic medium. The peak stress of adhesion is highly dependent on the elastic modulus of the adhesive. In weakly adhering systems, for example, between a release material and an adhesive, cavity growth is along the interface and is followed by facile coalescence of those cavities. Accordingly, the peak stress is low. For strongly adhering systems, cavity growth is not followed by extensive coalescence of the cavities and fibrils form. The force required to separate the adhesive from the substrate at this stage is related to the elongation properties of the adhesive.

One aspect of the present disclosure is that the adhesive tape bonds strongly to rough substrates (e.g., OSB, plywood, concrete, vinyl sidings, vinyl windows) and weakly to release substrate (e.g., release coating on the polymeric layer). In particular, the adhesive strongly resists the formation of cavities on the rough surface (i.e., adheres strongly) because the adhesive layer is soft and thick. The softness derived from the elastic modulus of the adhesive composition is sufficiently low to enable the deformation into the rough surface and sufficiently high to resist the formation of cavities therein. The adhesive tape bonds weakly to the release coating on the polymeric backing, easily forming cavities that coalesce quickly to dissipate the energy of adhesion.

In illustrative embodiments, the adhesive layer comprises rubber, filler, oil, and tackifying resin. In one embodiment, the adhesive layer comprises butyl rubber, natural rubber, carbon black, filler, oil, and tackifying resin. In another embodiment, the adhesive layer comprises butyl rubber, natural rubber, fillers, napthenic oil, and tackifying resin. All percentages are by weight unless stated otherwise. In another embodiment, the adhesive layer comprises about 8% to about 34% by weight of a butyl rubber, about 0% to about 26% of a natural rubber, about 6% to about 18% of carbon black, about 5% to about 20% of a filler that is not carbon black, about 10% to about 30% of naphthenic oil, and about 6% to about 19% of tackifying resin. In another embodiment, the adhesive layer comprises about 10% to about 22% of a butyl rubber, about 4% to about 18% of a natural rubber, about 10% to about 15% of carbon black, about 10% to about 18% of a filler that is not carbon black, about 15% to about 25% of naphthenic oil, and about 10% to about 16% of tackifying resin. In yet another embodiment, the adhesive layer comprises about 15% to about 19% of a butyl rubber, about 8% to about 15% of a natural rubber, about 11% to about 14% of carbon black, about 12% to about 16% of a filler that is not carbon black, about 18% to about 24% of naphthenic oil, and about 11% to about 15% of tackifying resin.

In illustrative embodiments, butyl rubber is the synthetic copolymer of isobutylene and isoprene. Butyl rubber includes those copolymers of isobutylene and isoprene ranging from very little isoprene, less than 0.1%, to isoprene concentrations up to about 5% of the composition. In one embodiment, the butyl rubber is virgin butyl rubber. In another embodiment, the butyl rubber is reclaimed or recycled butyl rubber. In yet another embodiment, the butyl rubber is a mixture of reclaimed and virgin butyl rubber. For example, illustrative embodiments may include virgin butyl rubber to reclaimed butyl rubber ratios of between 1:10 to 10:1. In one embodiment, the virgin butyl rubber to reclaimed butyl rubber ratio is about 1:1. In one embodiment, the butyl rubber has a Mooney viscosity ML (1+8) 125° C. of between about 40 and about 60 according to ASTM D1646. In another embodiment, the butyl rubber has a density of between about 0.9 and about 0.94 g/cm³.

In illustrative embodiments, the rubber may be polymeric isoprene. In one embodiment, the rubber is elastomeric and a thermoplastic. In another embodiment, the rubber includes homopolymers and copolymers of isoprene in one or both the cis- and trans-confirmations. In another embodiment, the rubber is virgin natural rubber. In another embodiment, the rubber is a synthetic polyisoprene. In yet another embodiment, the rubber is reclaimed or recycled natural rubber. In yet another embodiment, the rubber is a mixture of reclaimed and virgin rubber. In one embodiment the molecular weight of the rubber is between about 100,000 to about 1,000,000 g/mol.

In illustrative embodiments, the adhesive includes carbon black. Carbon black is the product of combusting incompletely heavy petroleum products such as FCC tar, coal tar, ethylene cracking tar, and vegetable oil. Illustratively, carbon black is amorphous carbon that has a high surface-area-to-volume ratio. Carbon black does not exist as primary particles; rather the particles are formed of aggregates of smaller particles. The structure of the aggregate is determined by the shape and degree of aggregate branching. Increasing structure may increase modulus, hardness, compounded viscosity, and improve the dispersibility of carbon black in the adhesive composition. In one embodiment, the adhesive includes carbon black having a primary particle size of between about 8 and about 300 nm in equivalent spherical diameter.

In illustrative embodiments, the adhesive composition includes a non-black filler. In one embodiment, the non-black filler is selected from a group consisting of calcium carbonate, kaolin clay, precipitated silica, talc, barite, wollastonite, mica, precipitated silicates, fumed silica, diatomite, and mixtures thereof. In one embodiment, the non-black filler is selected from a group consisting calcium carbonate, kaolin clay, precipitated silica and mixtures thereof. In another embodiment, the non-black filler is precipitated silica. In yet another embodiment, the non-black filler is kaolin clay. In one embodiment, the median particle size of the filler is between about 0.5 and about 1.5 microns in equivalent spherical diameter. In another embodiment, the median particle size of the filler is between about 0.9 and about 1.1 microns in equivalent spherical diameter. In another embodiment, the surface area of the filler is between about 5 and about 25 m²/gram. In yet another embodiment, the filler is a sedimentary kaolin clay having a density of 2.6 g/cm³.

In illustrative embodiments, the adhesive composition may include one or more naphthenic oils. Naphthenic oils are mineral oils or liquid petroleum by-products derived from the distillation of petroleum. Naphthenic oil may be transparent and colorless and include cycloalkanes. In one embodiment, the naphthenic oil has a molecular weight distribution corresponding to having an average of about 15 to about 40 carbons per molecule. In another embodiment, the naphthenic oil has a density of around 0.8 g/cm³. In another embodiment, the naphthenic oil has a viscosity at 40° C./100° C. of between about 40/5 and about 140/10 centiStokes (cSt), wherein 1 cSt is equal to 0.001 Pascal second. In yet another embodiment, the naphthenic oil has a viscosity at 40° C./100° C. of between about 80/7 and about 120/9 cSt.

In illustrative embodiments, the adhesive composition includes a tackifying resin. In one embodiment, the tackifying resin is a low molecular weight amorphous aromatic modified aliphatic hydrocarbon resin with a narrow molecular weight distribution. In one embodiment, the tackifying resin has a softening point of between about 80° C. and about 110° C. according to ASTM D 6090-97. In another embodiment, the tackifying resin has a softening point of between about 85° C. and about 100° C. In another embodiment, the tackifying resin has a viscosity at 25° C./60° C. of between about 10,000/300 and about 80,000/1,500 centiStokes (cSt). In another embodiment, the tackifying resin has a viscosity at 25° C./60° C. of between about 25,000/600 and about 60,000/1,200 centiStokes (cSt).

In illustrative embodiments, the tape comprises a polymeric backing material. In one embodiment, the polymeric backing comprises polyester. In another embodiment, the polymeric backing comprises a polypropylene. In another embodiment, the polymeric backing comprises a molecularly oriented polymer. In yet another embodiment, the polymeric backing comprises a biaxially oriented polymer (BOPP). In another embodiment, the polymeric backing comprises polyethylene. In another embodiment, the polymeric backing layer comprises at least two sheets, one of which can be printed on. In one embodiment the polymeric backing provides dimensional stability, high tensile, tear, and impact strengths. In yet another embodiment, the polymeric backing exhibits low water absorption and good resistance to oils, greases, strong acids, and organic solvents. In one embodiment, the polymeric backing includes a scrim or a fabric material. In another embodiment, the polymeric backing includes a foil. In another embodiment, the polymeric backing is metalized.

In illustrative embodiments, the polymeric backing layer has an outer surface and an inner surface and when in a roll the outer surface is in contact with a non-removable release layer and the inner surface is in contact with the adhesive layer. In one embodiment, the non-removable release layer comprises a platinum cured silicone. In another example, the non-removable release layer comprises polycarbamates. In one embodiment, the non-removable release layer is applied to the polymeric backing layer as a radiation-curable silicone release composition. For example, the release composition can be applied to the polymeric backing layer using roll coating, gravure coating, multi-roll coating, reverse roll, air knife, wire wound rod, or other coating process. Radiation-curable silicone release compositions photopolymerize or cure upon exposure to radiation. For example, the composition may include one or more photopolymerizable silicone compounds having one or more reactive polysiloxanes that cure (e.g., crosslink) upon exposure to radiation. The photopolymerizable silicone compounds may include monomers, oligomers, polymers, prepolymers, resinous materials and mixtures thereof.

In one illustrative embodiment, photopolymerization involves epoxy, acrylate, and vinyl ethers or other reactive groups polymerizing the presence of one or more photoinitiators (e.g., benzil dimethyl ketal benzoin, benzoin alkyl ethers, acyloin derivatives, benzophenone, acetophenone, Michler's ketone, acyl phosphine oxide derivatives, iodonium or sulfonium salts of fluorinated antimonates, pentafluorophenyl borates). These photopolymerization systems can be cured by radiation such as gamma, x-ray, electron beam, ultraviolet light or other energy. For ionizing radiation such as electron beam or gamma ray radiation, the photoinitiators may not be required for the free-radical systems. Exemplary compositions useful in the present invention include, without limitation, UV9400 and UV9380C (commercially available from General Electric Silicones), PC-600 and PC-702 (commercially available from Rhodia Silicones), and the like, and mixtures thereof.

In illustrative embodiments, the release coating is applied in a solvent-based or solvent-less system. In one embodiment, the solvent is selected from a group consisting of hexane, heptane, naphtha, cyclohexane, xylene, toluene, methyl ethyl ketone, cyclohexanone, and methyl iso-butyl ketone. In one embodiment, the release coating is coated on the polymeric layer at a weight of about 0.1 to about 1.0 grams per square meter (dry). In another embodiment, the release coating is coated on the polymeric layer at a coating weight of about 0.1 to about 0.6 grams per square meter.

In illustrative embodiments, the adhesive tape of the present disclosure is configured as a roll of self-wound flashing tape. In one embodiment, the length of tape on a roll is about 50 to about 500 linear feet. In another embodiment, the tape has a length of about 50 to about 100 linear feet per roll. In one embodiment, the width of the roll is between about 1 inch and about 12 inches. In another embodiment, the width of the roll is selected from group consisting of 1.25, 2, 3, 4, 6, 9, and 12 inches. In one embodiment, the polymeric backing is a light gauge polymeric backing. For example, a polymeric backing having a thickness of between about 0.5 and about 2 mils. Alternatively, instead of in a roll, the tape may be provided as a set of stacked strips having a desired pre-measured length.

In illustrative embodiments, the adhesive tape is configured to be hand-tearable. For example, the adhesive tape may be manufactured according to a process which imparts blems on the edge of the adhesive tape. Blems are essentially notches or discontinuities along an otherwise smooth edge. The blems provide starting points for tears that can propagate across the tape in a transverse direction. The blems enable the tape to be torn by hand without the use of scissors or other cutting devices. In one embodiment, the blems, along with the tear propagation properties of the polymeric composition and the adhesive composition combine to provide the tape with hand-tearability.

In illustrative embodiments, the adhesive tape has a thickness of about 11 to about 90 mils according to ASTM D-3767. In one embodiment, the adhesive tape has a thickness of about 20 to about 60 mils. In another embodiment, the adhesive tape has a thickness of about 25 to about 49 mils. In one embodiment, the adhesive tape has a machine direction tensile strength according to ASTM D412-97 of greater than about 290 psi (2000 kn/m²). In another embodiment, the adhesive tape has a tranverse direction tensile strength according ASTM D412-97 of greater than about 300 psi (2411 kn/m²). In one embodiment, the adhesive tape has an elongation according to ASTM D412-97 of between about 2% and about 200%. In another embodiment, the adhesive tape has an elongation of between about 20% and about 150%. In another embodiment, the adhesive tape has an elongation of between about 70% and about 100%. In one embodiment, the adhesive tape has a permeance according to ASTM E96-94 of less than about 0.5 perm. In another embodiment, the adhesive tape has a permeance of less than about 0.3 perm. In yet another embodiment, the adhesive tape has a permeance of less than about 0.1 perm.

In illustrative embodiments, a method of producing a roll of flashing tape comprises shear coating a pressure-sensitive adhesive composition according to the present disclosure onto a polymeric backing to make a coated film, winding the coated film around a core positioned on a master drum without the introduction of a removable release liner, and score cutting the coated film to produce the roll of flashing tape. In one embodiment, the shear coating includes positioning the polymeric backing between a first roll and a second roll of a calendar, the first roll being in contact with the polymeric backing and the second roll positioned to define a gap between the polymeric backing and the second roll. In another embodiment, the shear coating includes adjusting the gap so that the polymeric backing having a thickness of between about 0.5 mils and about 2 mils is coated with the pressure-sensitive adhesive composition at a thickness of between about 9 and about 60 mils. In yet another embodiment, the score cutting introduces minor blems on the edges of the flashing tape which allows the tape to be hand-tearable.

In illustrative embodiments, the temperature of applying the adhesive to the polymeric backing is controlled such that application of the adhesive does not cause the backing to droop during manufacture yet at a temperature sufficient to enable the adhesive to wet out the surface of the polymeric backing. As used herein, wetting out means that the adhesive composition flows and covers the entire application surface of the polymeric backing. This is contrasted to applications in which beads of adhesive form on the surface due to the higher surface energy of the adhesive in comparison to the polymeric backing. In illustrative embodiments, the polymeric backing may be surface treated on one side so that the adhesive wets out the polymeric backing. For example, the surface to be contacted with the adhesive composition may be treated with a corona discharge, flame treated, or primed. In one embodiment, the adhesive is applied at a temperature of about 250° C. or lower to a polymeric backing comprising BOPP. In another example, the adhesive may be applied at a temperature of about 350° C. to a polymeric backing comprising polyester.

A feature of the tape of the present disclosure is that it can be unwound from a roll and applied to a surface in several overlapping layers to extend the effective width of the tape. Thus, while the tape can be easily unwound from the roll without the adhesive layer disadvantageously sticking to the opposing face of the tape, the adhesive layer of the tape strip does adhere to the opposing face of an overlapping strip of tape applied to a surface.

An additional feature of the tape of the present disclosure is that the free end of the rolled tape stays tacked down to the roll and does not tend to unravel.

In an alternative exemplary embodiment the adhesive layer may be comprised of a plurality of layers of one or more adhesives as disclosed herein.

In an alternative exemplary embodiment the polymeric layer may be comprised of a plurality of layers of one or more materials as disclosed herein.

It is to be understood that the tape construction as described herein can be used for purposes other than flashing, such as, but not limited to, liners, sealing of other gaps or joints, duct tape, and the like.

Those standard methods referred to herein, such as ASTM standard methods, are herein incorporated by reference in their entireties. The following example is set forth for purposes of illustration only. Parts and percentages appearing in such example are by weight unless otherwise stipulated.

### EXAMPLES

### Example 1

To produce an adhesive formulation capable of performing in a tape application, the ingredients, which commonly include rubber, inorganic filler, modifiers, antioxidants, colorants, and a minor portion of tackifying resins, were mixed in rubber processing equipment such as a continuous mixing extruder or an internal batch mixer.

An example of an adhesive formulation is presented in Table 1.

TABLE 1
Adhesive Formulation

| Component | Percent |
|---|---|
| Rubber | 52% |
| Antioxidant | 0.5% |
| Mineral fillers | 14.2% |
| Oil | 20.7% |
| Tackifying resin | 13.0% |

Internal batch mixers are sold under different brand names. An example of a commercially available internal batch mixer capable of mixing a rubber based adhesive is a Farrel Banbury™ mixer. A Farrel Banbury mixer used rotating blades to chop, masticate, compound, and/or mix ingredients in a temperature controlled chamber. Internal batch mixers process ingredients for adhesives including but not necessarily limited to rubber, fillers, modifiers such as oils, and antioxidants, such as those found in Table 1.

When an internal batch mixer is used, adhesives are sometimes, but not always, further processed and/or mixed utilizing a secondary step. In this secondary process, equipment such as a two-roll batch mixer or a sigma blade mixing extruder is often used to incorporate additional tackifying agents or other ingredients.

In addition to internal batch mixer/mill combinations, additional equipment capable of successfully producing adhesives include ribbon mixers, continuous mixing extruders, and sigma blade mixing extruders.

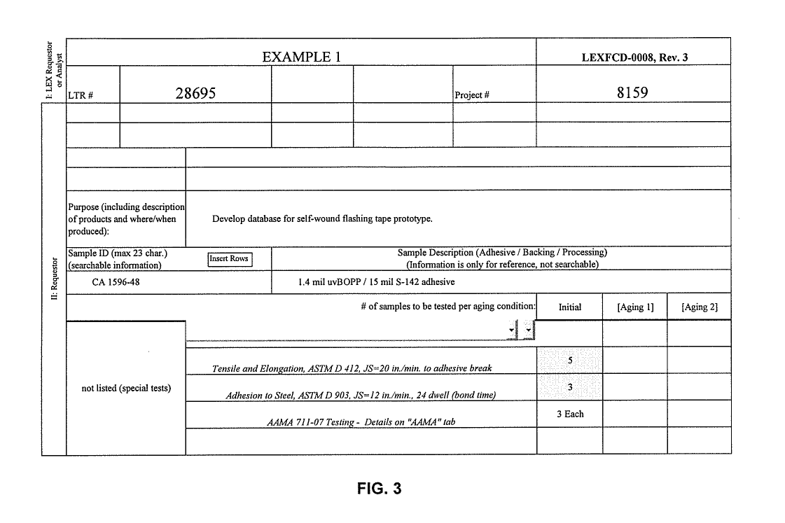

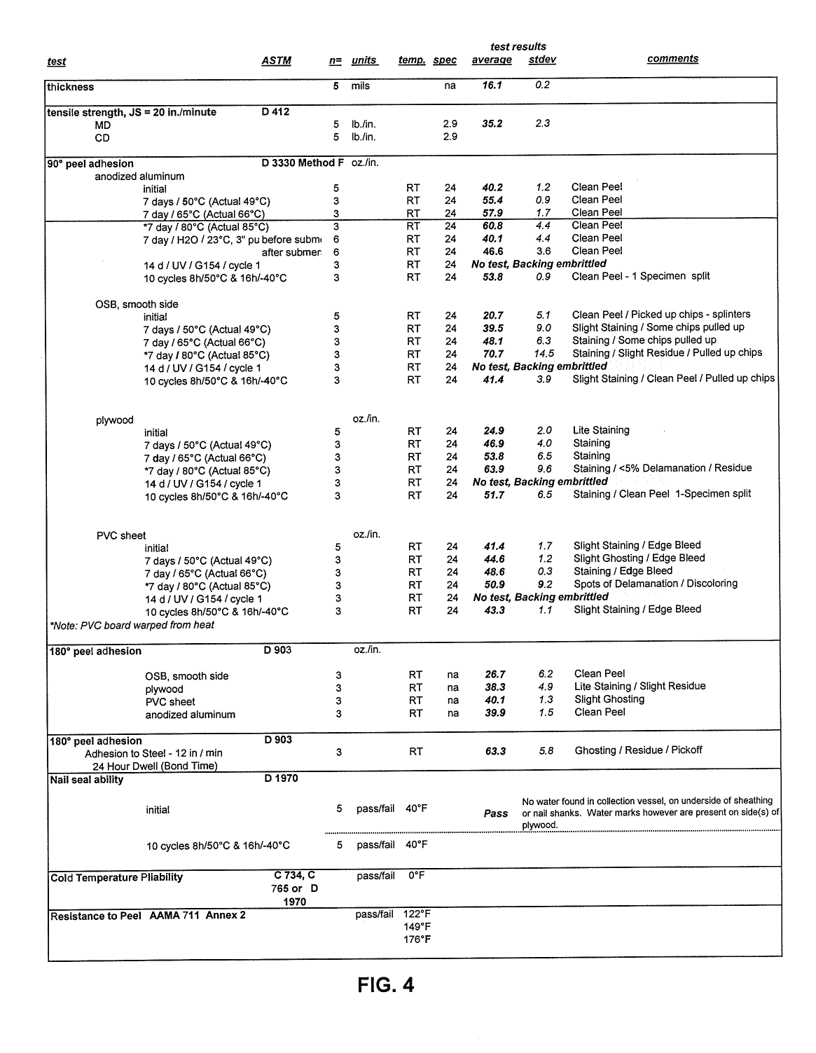

FIGS. 3 and 4 show tables of data from a sample of tape that was formulated according to the above formulation.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

1. An adhesive tape, comprising:
at least one polymeric layer formed of a polymeric material and
at least one adhesive layer formed of a pressure-sensitive adhesive material,
wherein the polymeric backing layer and the pressure-sensitive adhesive layers are configured as a self-wound flashing tape without a removable release liner and wherein the tape can be unwound without causing damage to the tape or loss of adhesive from the adhesive layer.

2. The adhesive tape of claim 1, wherein the polymeric backing layer is between about 0.5 and about 2 mils in thickness and the pressure-sensitive adhesive layer is between about 9 mils and about 60 mils in thickness.

3. The adhesive tape of claim 2, wherein a ratio of thickness of the pressure sensitive adhesive layer and the polymeric backing layer is greater than about 10:1.

4. An adhesive tape, consisting essentially of:
at least one polymeric layer formed of a polymeric material and
at least one adhesive layer formed of a pressure-sensitive adhesive material,
wherein the polymeric backing layer and the pressure-sensitive adhesive layers are configured as a self-wound flashing tape without a removable release liner and wherein the tape can be unwound without causing damage to the tape or loss of adhesive from the adhesive layer.

5. The adhesive tape of claim 1, wherein the tape is hand tearable.

6. The adhesive tape of claim 1, wherein the tape is provided in roll form.

7. The adhesive tape of claim 1, wherein the tape is provided in strip form and, when applied, strips can overlap and adhere to each other.

8. The adhesive tape of claim 1, wherein the adhesive comprises 52% rubber, 0.5% antioxidant, 14.2% mineral fillers, 20.7% oil and 13.0% tackifying resin.

9. An adhesive tape, comprising:
at least one polymeric layer formed of a release-treated polyester material and
at least one adhesive layer formed of a butyl-based adhesive material,
wherein the polymeric backing layer and the pressure-sensitive adhesive layers are configured as a self-wound flashing tape without a removable release liner and wherein the tape can be unwound without causing damage to the tape or loss of adhesive from the adhesive layer.

10. A method of producing a roll of flashing tape, the method comprising the steps of comprising
coating a pressure-sensitive adhesive composition onto a polymeric backing to make a coated film,
winding the coated film around a core positioned on a master drum without the introduction of a removable release liner, and
score cutting the coated film to produce a roll of flashing tape.

11. The method of claim 4, wherein the coating is die profile feed coating or shear coating.

12. The method of claim 4, wherein the coating is shear coating and the shear coating step includes the step of positioning the polymeric backing between a first roll and a second roll of a calendar, the first roll being in contact with the polymeric backing and the second roll positioned to define a gap between the polymeric backing and the second roll.

13. The method of claim 4, wherein the coating is shear coating and the shear coating step includes the step of adjusting the gap so that the polymeric backing having a thickness of between about 0.5 mils and about 2 mils is coated with the pressure-sensitive adhesive composition at a thickness of between 9 and 60 mils.

14. The method of claim 7, wherein the shear coating step further includes the step of positioning the polymeric backing between a first roll and a second roll of a calendar, the first roll being in contact with the polymeric backing and the second roll positioned to define a gap between the polymeric backing and the second roll.

15. The method of claim 4, wherein the score cutting step introduces minor blems on the edges of the flashing tape which allows the tape to be hand-tearable.

16. The method of claim 4, wherein the score cutting step uses a pinking blade that introduces a predetermined pattern on the edges of the flashing tape which allows the tape to be hand-tearable.
